(19) United States
(12) Patent Application Publication
(10) Pub. No.: US 2022/0123383 A1
(43) Pub. Date: Apr. 21, 2022

(54) BATTERY THERMAL MANAGEMENT DEVICE AND METHOD FOR IMPROVING SAFETY AND PERFORMANCE OF BATTERY

(71) Applicant: Standard Testing & Engineering Inc., Daejeon (KR)

(72) Inventors: SEUNGHYUN LEE, Daejeon (KR); WOOJUNG SHIN, Daejeon (KR); HANSOL PARK, Daejeon (KR); JUNHYUN PARK, Sejong-si (KR)

(73) Assignee: Standard Testing & Engineering Inc., Daejeon (KR)

(21) Appl. No.: 17/103,113

(22) Filed: Nov. 24, 2020

(30) Foreign Application Priority Data
Oct. 19, 2020 (KR) 10-2020-0135555

(51) Int. Cl. H01M 10/613; H01M 10/6569; H01M 10/6568; H01M 10/6556; H01M 10/48; H01M 2/10; A62C 5/02; A62D 1/02

(52) U.S. Cl. CPC H01M 10/613; H01M 10/6569; H01M 10/6568; H01M 10/6556; H01M 2200/00; H01M 2/1016; A62C 5/02; A62D 1/0071; H01M 10/486

(57) ABSTRACT

The present invention relates to a thermal management system and a thermal management method for cooling a heat-generating electronic device such as a battery and for extinguishing a fire occurring in the heat-generating electronic device. More particularly, the present invention relates to a thermal management system and a thermal management method that are capable of cooling a heat-generating electronic device such as a battery of an energy storage system (ESS) in various ways at multiple stages and of extinguishing a fire in the heat-generating electronic device. The present invention has an effect of preventing fire by cooling a heating-generating element such as a battery of an energy storage device. In addition, the present invention has an effect of stopping a cooling operation and starting a fire extinguishing operation when a fire occurs during the cooling operation.

### CROSS REFERENCE TO RELATED APPLICATION

A claim for priority under 35 U.S.C. § 119 is made to Korean Patent Application No. 10-2020-0135555 filed on Oct. 19, 2020 in the Korean Intellectual Property Office, the entire contents of which are hereby incorporated by reference.

### BACKGROUND OF THE INVENTION

### 1. Field of the Invention

The present invention relates to a thermal management system and a thermal management method for cooling a heat-generating electronic device such as a battery and for distinguishing a fire occurring in the heat-generating electronic device. More particularly, the present invention relates to a thermal management system and a thermal management method that are capable of cooling a heat-generating electronic device such as a battery of an energy storage system (ESS) in various ways at multiple stages and of distinguishing a fire in the heat-generating electronic device.

### 2. Description of the Related Art

Recently, the use of energy storage systems (ESS) that store energy to be used at a desired time is rapidly and widely spreading. Such an energy storage system (ESS) is composed of a power storage unit such as a lithium-ion battery (LiB), a power control device (also called power conversion system (PCS)), and an energy management system (EMS). Among various kinds of power storage units, lithium-ion batteries are vulnerable to fire that occurs due to high temperature and heat.

With the widespread use and increase in the capacity of lithium-ion batteries, it is not rare that battery fire accidents are reported. If efficient cooling of batteries is not performed, more fires would be reported. In particular, fires caused by lithium-ion batteries have all of the fire characteristics of class A, class B, class C, and class D. That is, the fires in lithium-ion batteries exhibit the characteristics of class A (which means fire of general combustible materials) because the lithium-ion batteries include separators and pouches that are made of a plastic material. Unlike rechargeable batteries used in early days, recent lithium-ion batteries use, as an electrolyte, an organic solvent that is a flammable liquid. Therefore, the lithium-ion battery fire exhibits the characteristics of class B (which means fire of oil). In addition, since lithium-ion batteries exist in a state of being charged with electric energy, the lithium-ion batteries act as ignition sources. Therefore, the fire thereof exhibits the characteristics of class C (which means fire caused by an ignition). In addition, since lithium ion batteries include metal components, the fire thereof also exhibits the characteristics of class D (which means fire of metal).

Therefore, there is a problem in that it is not easy to cope with ESS fires due to complex characteristics, and moreover, there is a more serious problem that lithium-ion batteries exhibit unique characteristics such as thermal runaway and re-ignition.

The term “thermal runaway” refers to a rapid increase in temperature due to self-heating of a battery cell, and it begins with the collapse of a polymer membrane disposed between an anode and a cathode. Polyolefin-based polymers such as polyethylene or polypropylene, which are materials commonly used for separators, have a melting point in a range of 125 to 160° C. and have poor stability at high temperatures. When the separator is damaged, the cathode and the anode come in direct contact with each other, resulting in rapid release of energy charged therein and thermal decomposition of an organic solvent (i.e., electrolyte), thereby generating flammable gas (VOC gas). When the pressure rises to exceed a certain level due to gas expansion, flammable gas and electrolyte leak out of the battery cell and ignite. Causes of thermal runaway include perforation of a separator caused by a mechanical impact, electrical factors such as overcharging or overdischarging, and defects in the product itself. In some cases, it is also possible that batteries are burned due to external fires that are not related to the batteries. The term “re-ignition” refers to a phenomenon in which a fire starts from a battery and the battery fire is first extinguished by a fire extinguishing activity, but combustion starts again while making a flame after a certain period of time after the fire is extinguished. In the case of a fire that occurs in a battery composed of a large number of battery cells, even though the fire of a battery cell that is first ignited is extinguished, another battery cell that is adjacent to the firstly ignited battery is thermally shocked by thermal conduction or radiant heat, resulting in thermal runaway thereof due to their own electrical energy. This results in fire starting again.

Due to the thermal runaway and re-ignition of the lithium-ion battery, it is almost impossible to extinguish the fire if the initial suppression of a battery fire fails. Up to the present, battery fires have been commonly controlled with water. In a fire site, there is a risk of an electric shock and explosive combustion due to the generation of metallic substances and combustible gases in the battery. It also causes fatal damage to peripheral devices.

Therefore, to prevent such a battery fire in advance, pre-cooling is the most important preventive measure. There is a cooling method that lowers the temperature of a battery by immersing the battery in an insulating coolant. This direct contact cooling technology cools an electronic device by making a direct contact between the electronic device and an insulating coolant, without using an intermediate medium that transfers heat. That is, the technology has an advantage of high cooling performance because a coolant having low thermal resistance and having lower density than air is used. In a case where a fluid containing fluorine and having a boiling point is used as a thermal management medium, the liquid functions as a thermal management medium in normal conditions but functions as a fire-extinguishing agent when a battery fire occurs. Specifically, an insulating fluid present around a battery evaporates to absorb heat and breaks a chain reaction that is caused in the process of thermal decomposition of the insulating fluid during the battery fire.

However, the extinguishing function of the insulating coolant is very limited because only a small amount of insulating coolant can be contained in a battery casing. In addition, the extinguishing performance of the insulating coolant is poor. That is, the extinguishing performance corresponds to the level of the latent heat of evaporation of the insulating coolant at most. Therefore, when a big fire occurs, it is impossible to extinguish the fire with the insulating coolant.

On the other hand, for high efficiency cooling and extinguishing, a battery casing needs to be fully filled with an insulating coolant. However, the use of a large amount of an expensive insulating coolant results in an increase in manufacturing cost and in a considerable increase in weight.

Accordingly, to use only a minimum amount of an insulating coolant, a method of circulating, cooling, and recycling the insulating coolant has been developed. However, in this case, although the amount of the insulating coolant decreases due to losses attributable to evaporation and leakage of the insulating coolant, it is difficult to replenish the insulating coolant. In addition, when a fire occurs even though cooling is performed, there is a problem in that the fire cannot be extinguished with only the insulating coolant.

Therefore, research has been actively conducted on battery thermal management systems for improving cooling performance and ensuring battery performance and on various types of fire extinguishing systems for rapid extinguishing of fire. In addition, there is a need for a device that enables fire extinguishing when a fire occurs during thermal management of a battery and which can selectively provide a suitable extinguishing agent among many various kinds of extinguishing agents according to the type of fire.

On the other hand, a foam-type extinguishing agent based on a synthetic surfactant has been reported. The agent has as an oxygen blocking effect (suffocating). Specifically, the agent generates bubbles with a high (i.e., 50-fold) expansion rate to cover fire with the bubbles, thereby preventing contact between combustible gases and oxygen. In addition, since the agent generates bubbles that are very rich in moisture, the agent improves the cooling efficiency. For those reasons, the agent has been found to be very effective in coping with fire of an ESS having thermal runaway and re-ignition characteristics. Therefore, there is suggested a thermal management system that is suitable for an ESS, the system being a combination of a cooling device using an insulating coolant and a fire extinguishing device using a foaming agent.

### DOCUMENT OF RELATED ART

### Patent Document

(Patent Document 1) Korean Patent No. 10-2031645 (Oct. 14, 2019)

### SUMMARY OF THE INVENTION

An objective of the present invention is to provide a control system and method for managing and controlling cooling of and fire in an electric or electronic device, such as an energy storage device (ESS), which generates a large amount of heat.

Another objective of the present invention is to provide a battery thermal management device and method involving a cooling operation and an extinguishing operation that is performed when a fire occurs despite cooling being performed.

A further objective of the present invention is to provide a battery thermal management device and method capable of freely adjusting the level of an insulating coolant for efficient thermal management.

A yet further objective of the present invention is to provide a battery thermal management device and method in which an arrangement position of a circulation pump is suitably determined to secure an improved effective suction head compared to the storage capacity for an insulating coolant.

A yet further objective of the present invention is to provide a system and a control method that use a pressurized gas of a fire extinguishing device so that when a circulation pump malfunctions, the pressurized gas is used instead of the circulation pump.

Other objectives and advantages of the present invention can be more clearly understood from the following description and embodiments of the present invention. In addition, it will be appreciated that the objectives and advantages of the present invention can be implemented by the means recited in the claims and combinations thereof.

In order to accomplish one of the objectives, there is provided a battery thermal management system having a fire extinguishing function, the system including: a battery reception device 100 accommodating a battery unit 120 and including a casing 110 containing an insulating coolant; the battery unit 120 in which multiple battery cells 121 are stacked; a circulation pump 130 disposed at a side of the battery unit 120 to pump the insulating coolant out of the casing 110; a cooling unit 200 that is connected to the circulation pump 130 and into which the insulating coolant discharged from the casing 110 is introduced when the circulation pump 130 is operated; a storage vessel 300 in which the insulating coolant cooled by and discharged from the cooling unit 200 is contained; an insulating coolant supply valve 320 installed on a path through which the insulating coolant discharged from the storage vessel 300 flows into the casing 110 to block or unblock the path or adjust a flow rate of the insulating coolant flowing through the path; a temperature sensing unit 170 that measures a temperature of an inner space of the battery 120 or the casing 110 or a temperature of the insulating coolant; and a controller 160 that controls operation of at least one of the circulation pump 130, the cooling unit 150, and the supply valve according to a temperature detection signal input from the temperature sensing unit 170.

The system may further include a fire extinguishing device 500 containing an extinguishing agent and an extinguishing agent supply valve 420 installed on a path through which the extinguishing agent discharged from the fire extinguishing device 500 flows into the casing 110 to block or unblock the path and to control a flow rate of the extinguishing agent flowing into the casing 110.

The fire extinguishing device 500 may include an extinguishing agent storage vessel 510 to contain the extinguishing agent and a pressurized gas storage vessel 520 to contain a pressurized gas. The system may further include: a pressurized gas pipe 530 connected between the storage vessel 300 and the fire extinguishing device 500; and a pressurized gas supply valve 540 installed on a path of the pressurized gas pipe 530. When the pressurized gas supply valve 540 is opened, the pressurized gas is supplied to the storage vessel 300 from the fire extinguishing device 500, and the insulating coolant contained in the storage vessel 300 is pressurized and then supplied to the battery reception device 100.

When a detection value measured by the temperature sensing unit 170 is equal to or greater than a reference value, the controller 140 may open the insulating coolant supply valve, may increase an opening of the insulating coolant supply valve, may control the circulation pump not to pump out the insulating coolant, or may control the circulation pump to reduce a discharge rate of the insulating coolant so that a flow rate of the insulating coolant introduced into the battery reception device 100 is higher than a flow rate of the insulating coolant discharged from the battery reception device 100, thereby raising a level of the insulating coolant in the battery reception device 100.

When the detection value measured by the sensing unit 170 is less than the reference value, the controller 140 may close the insulating coolant supply valve 320, may reduce the opening of the insulating coolant supply valve 320, may control the circulation pump 130 to start pumping the insulating coolant, or may control the circulation pump to increase the discharge rate of the insulating coolant so that the flow rate of the insulating coolant discharged from the battery reception device 100 is higher than the flow rate of the insulating coolant introduced into the battery reception device 100, thereby lowering the level of the insulating coolant in the battery reception device 100.

When it is determined that a fire occurs in the storage vessel 300, the controller 140 may close the insulating coolant supply valve 320 to prevent the insulating coolant from being introduced into the storage vessel 300 and open the extinguishing agent supply valve 420 to allow the extinguishing agent to flow into the battery reception device 100 from the fire extinguishing device 500.

When it is determined that a state in which the detection value measured by the temperature sensing unit 170 is equal to or greater than an evaporation temperature of the insulating coolant lasts for a predetermined period of time or longer, the controller 14 may close the extinguishing agent supply valve 420 to prevent the extinguishing agent from being supplied and may open the insulating coolant supply valve 320 to allow the insulating coolant to be supplied from the storage vessel 300.

The fire extinguishing device 500 may include an extinguishing agent storage vessel 510 to contain the extinguishing agent and a pressurized gas storage vessel 520 to contain a pressurized gas. The system may further include: a pressurized gas pipe 530 connected between the storage vessel 300 and the fire extinguishing device 500; and a pressurized gas supply valve 540 installed on a path of the pressurized gas pipe 530. In order for the insulating coolant to be supplied to the battery reception device 100 from the storage vessel 300, the controller 130 may open the pressurized gas supply valve 540. Thus, the pressurized gas is supplied to the storage vessel 300 from the fire extinguishing device 500, and the insulating coolant contained in the storage vessel 300 is pushed out to be introduced into the battery reception device 100.

In order to accomplish one of the objectives, there is provided a method of managing heat of a battery while performing a fire extinguishing function when it is necessary, the method including:

introducing an insulating coolant into a casing 110 of a battery reception device 100 configured to accommodate a battery unit 120 composed of multiple battery cells 121 stacked on each other so that the insulating coolant and the battery unit 120 come into direct contact with each other; discharging the insulating coolant that falls down, to the outside of the casing 110 with a circulation pump 130; cooling the discharged insulating coolant with a cooling unit 200 through heat exchange; discharging the cooled insulating coolant to a storage vessel 300 so that the cooled insulating coolant is stored in the storage vessel 300; and adjusting a flow rate of the insulating coolant supplied into the battery reception device 100 by opening or closing an insulating coolant supply valve 320 installed in a path between the storage vessel 300 and the battery reception device 100.

The method may further include: detecting an internal temperature of the battery unit 120 or the casing 110 or a temperature of the insulating coolant contained in the casing 110 with a temperature sensing unit 170; and temporarily raising a level of the insulating coolant in the battery reception device 100 when it is determined that the detected temperature is equal to or higher than a reference temperature. The raising of the level of the insulating coolant may include opening the insulating coolant supply valve 320, increasing an opening of the insulating coolant supply valve 320, or controlling the circulation pump 130 to stop discharging the insulating coolant or to reduce a discharge rate of the discharged insulating coolant, thereby controlling the flow rate of the insulating coolant such that the flow rate of the insulating coolant introduced into the battery reception device 100 is higher than the flow rate of the insulating coolant discharged from the battery reception device 100. This may result in the level of the insulating coolant being raised in the battery reception device 100.

The method may further include: determining that a fire has occurred in the battery reception device 100; and supplying an extinguishing agent to the battery reception device 100. The supplying of the extinguishing agent may include: opening an extinguishing agent supply valve 420 so that the extinguishing agent flows into the battery reception device 100.

The method may further include: detecting that a state in which the temperature measured by the temperature sensing unit 170 is higher than an evaporation temperature of the insulating coolant lasts for a predetermined period of time or longer; and blocking re-ignition in the battery reception device 100. The blocking of the re-ignition may include: stopping the extinguishing agent from flowing into the battery reception device 100 by closing the extinguishing agent supply valve 420; and allowing the insulating coolant to flow into the battery reception device 100 from the storage vessel 300 by opening the insulating coolant supply valve 320.

The method may further include: opening a pressurized gas supply valve 540 connected between a pressurized gas storage vessel 520 of the fire extinguishing device 500 and the storage vessel 300; transferring a pressurized gas to the storage vessel 300 from the pressurized gas storage vessel 520; and allowing the introduced pressurized gas to push out the insulating coolant in the storage vessel 300 so that the insulating coolant is pressurized and supplied to the battery reception device 100.

The present invention has an effect of preventing fire by cooling a heating-generating element such as a battery of an energy storage device.

In addition, the present invention has an effect of raising the level of the insulating coolant so that the battery can be sufficiently immersed in the insulating coolant when the temperature of the battery does not decrease to a desired temperature range or is maintained in a high temperature range even though a cooling operation is performed.

In addition, the present invention has an effect of stopping a cooling operation and starting a fire extinguishing operation when a fire occurs during the cooling operation.

In addition, the present invention has a characteristic of using a fire extinguishing device and a storage vessel instead of a circulation pump, thereby having an effect of supplying an insulating coolant to a battery without using an additional complicated configuration or structure.

In addition, the present invention has an effect of minimizing the required amount of insulating coolant by ensuring an effective suction head relative to the storage capacity for the insulating coolant.

### BRIEF DESCRIPTION OF THE DRAWINGS

FIG. 1 is a diagram illustrating the appearance of a battery reception device used in one embodiment of the present invention;

FIG. 2 is a diagram illustrating the internal structure of the battery reception device used in one embodiment of the present invention;

FIG. 3 is a diagram illustrating a cross-section of the internal structure of the battery reception device used in one embodiment of the present invention;

FIG. 4 is a diagram illustrating the internal structure of the battery reception device used in one embodiment of the present invention;

FIG. 5 is a diagram illustrating a state in which the insulating coolant is cooled and supplied to the battery reception device;

FIG. 6 is a diagram illustrating a battery thermal management device equipped with a fire extinguishing device, according to one embodiment of the present invention;

FIG. 7 is a diagram illustrating a connection structure of a battery thermal management device according to one embodiment of the present invention;

FIGS. 8A and 8B are diagrams illustrating a state in which a level of an insulating coolant in a battery reception device changes, according to one embodiment of the present invention;

FIG. 9 is a diagram illustrating the connection structure of the battery thermal management device according to one embodiment of the present invention;

FIG. 10 is a flowchart illustrating a thermal management control method according to one embodiment of the present invention;

FIG. 11 is a diagram illustrating a battery thermal management device according another embodiment of the present invention; and

FIG. 12 is a diagram illustrating a state in which a level of an insulating coolant in a battery reception device changes, according to one embodiment of the present invention.

### DESCRIPTION OF THE PREFERRED EMBODIMENTS

The above objectives, features, and advantages of the present invention will become more apparent from the following detailed description taken in conjunction with the accompanying drawings. With reference to the following detailed description and the accompanying drawings, the ordinarily skilled in the art may easily embody the technical concept of the invention. Further, in describing the exemplary embodiments of the present invention, well-known functions or constructions will not be described in detail since they may obscure the gist of the present invention. Hereinafter, preferred embodiments of the present invention will be described in detail with reference to the accompanying drawings.

It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, integers, steps, operations, elements, and/or components. Also, the terms “˜part”, “˜unit”, “module”, “apparatus”, “device” and the like mean a unit for processing at least one function or operation and may be implemented by a combination of hardware and/or software.

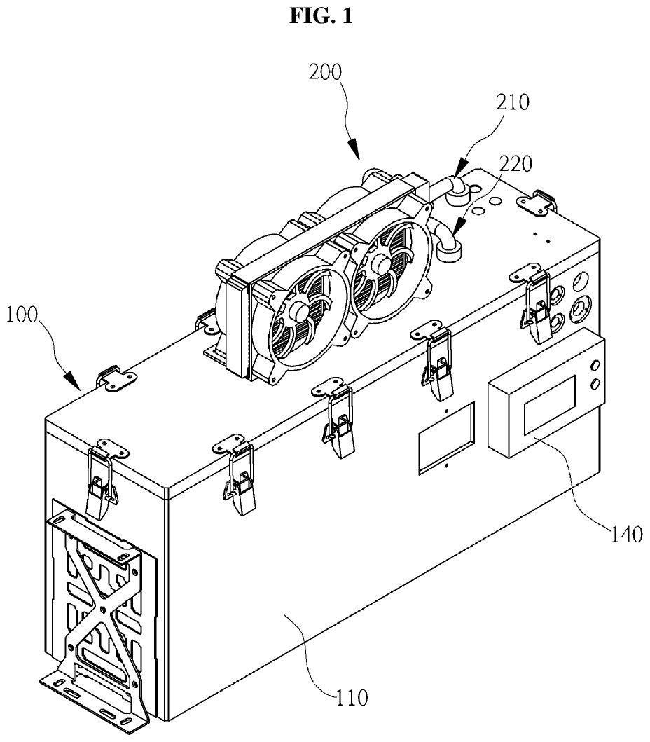

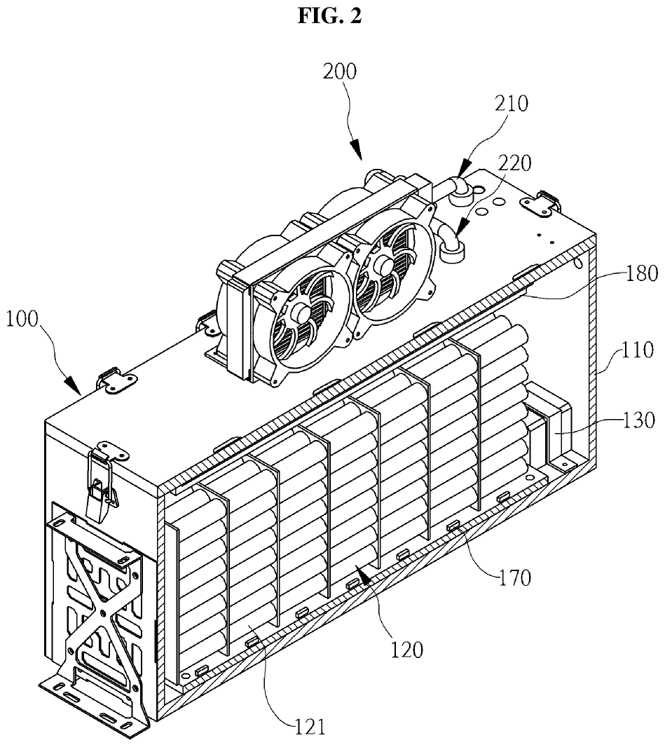

FIG. 1 is a diagram illustrating the appearance of a battery reception device used in one embodiment of the present invention, and FIG. 2 is a diagram illustrating the internal structure of the battery reception device. Referring to FIGS. 1 and 2, a battery thermal management device includes:

a battery reception device 100 including a casing 110 defining the outer form of the battery reception device; a cooling unit 200 disposed on the top surface of the casing 110; and a controller 140 disposed on a side surface of the casing 110 and configured to monitor and control operation of each of the constituent elements.

Although the illustration shows that the cooling unit 200 is installed on the top surface of the casing 110 and the controller 140 is installed on the side surface of the casing 110, it should be understood that the installation positions are not limited thereto. The cooling unit 200 and the controller 140 may be installed at other positions, may be separately and discretely disposed at remote positions, or may be mounted in combination with other components. The controller 140 may be disposed outside the casing 110 or may be separately provided as a control panel so as to be manually operated. Alternatively, the controller 140 may be provided as a control booth that controls the overall operation of an energy storage system (ESS). The controller 140 may be provided in a structure in which a plurality of ESS systems is disposed. The controller 140 may be configured in combination with various devices such as a control center, server, and PC.

In the casing 110, a plurality of battery units 120 is disposed. Each battery unit 120 includes multiple battery cells 121 that are stacked on each other. Each battery cell 121 may be replaced with an electronic device or a heat-generating element. The battery unit 120 should be interpreted as a configuration including not only the battery cells but also equivalent components.

The casing 110 is structured such that a certain level of an insulating coolant can be maintained in the casing 110. A circulation pump 130 disposed on one side of the casing 110 pressurizes and pumps the insulating coolant upward to be discharged from the casing 110. The discharged insulating coolant flows into the cooling unit 200 through a circulation pipe 210 and is cooled through heat exchange. The cooled insulating coolant is discharged from the cooling unit 200 through a discharge pipe 220 and is introduced into the battery reception device 100. A dispersing unit 180 disposed in an upper portion of an inner space of the casing 110 sprays the insulating coolant so that the insulating coolant is evenly and widely spread while falling down into the casing 110.

The insulating coolant is a phase transition non-conductive fluid and is a non-conductive liquid material including synthetic hydrocarbons such as hydrofluoroether (HFE), fluoroketone (FK), and perfluorocarbon (PFC). The level of the insulating coolant contained in the casing 110 is determined such that a lower portion of the stack of the battery cells 121 stacked from the bottom of the casing 110 is submerged.

The battery unit 120 is a stack of battery cells 121 that are heat-generating elements, and the battery cells 121 come in various forms. For example, the battery cells 121 are cylindrical cells, prismatic cells, or pouch-type cells. The battery unit 120 may be a battery module used in an ESS system. Alternatively, the battery unit 120 may be replaced with a heat-generating element such as a storage device, a server, or a data center, an electronic device (for example, personal computer), an electric device (for example, condenser), or any equivalent thereto.

The cooling unit 200 includes any device that can cool a fluid. Specifically, the cooling unit 200 illustrated in the drawings is a heat exchanger using a cooling chamber and a cooling fan. The cooling chamber is connected to the circulation pipe 210 at an upper portion of a center portion thereof and is connected to the discharge pipe 220 at a lower portion thereof. In addition, multiple cooling fans are disposed at both sides of the cooling chamber. The insulating coolant in the cooling chamber is cooled through heat exchange by the cooling fans. The cooled insulating coolant is discharged through the discharge pipe 220. The insulating coolant is introduced into the dispersing unit 180 disposed under a cover of the casing 110 through the discharge pipe 220.

A temperature sensing unit 170 is a sensor that measures temperature. The temperature sensing unit 170 is preferably disposed directly below the battery cells 121 or between the battery cells 121, but the installation position is not limited thereto. The temperature sensing unit 170 measures the temperature of the battery cells 121, the temperature of the insulating coolant on the bottom of the casing, the temperature of the insulating coolant falling from above, or an internal air temperature in the casing 110. The measured temperature is transmitted to the controller 140.

The circulation pump 130 is a pump that circulates the insulating coolant through the cooling unit 200, and is disposed at one side of the battery unit 120 provided on the bottom of the casing 110. Specially, the circulation pump 130 is disposed in a suction head recess formed on the bottom of the casing 110. That is, the circulation pump 130 is disposed to be lower than the bottom of the casing 110. Preferably, the circulation pump 130 is disposed to be submerged at a position lower than the required level of the insulating coolant contained in the casing 110. During the operation of the circulation pump 130, the circulation pump 130 pumps the insulating coolant out of the casing through a suction port thereof and supplies the insulating coolant to the cooling unit 200 through the discharge pipe 210 to which a discharge port of the circulation pump 130 is connected.

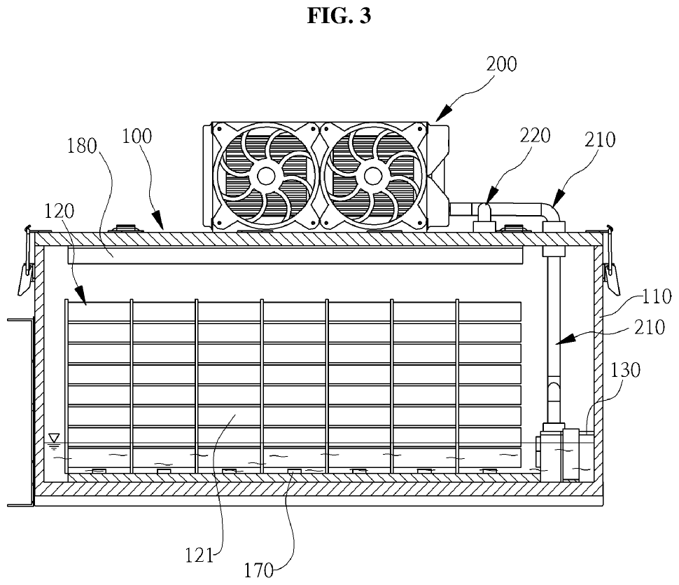

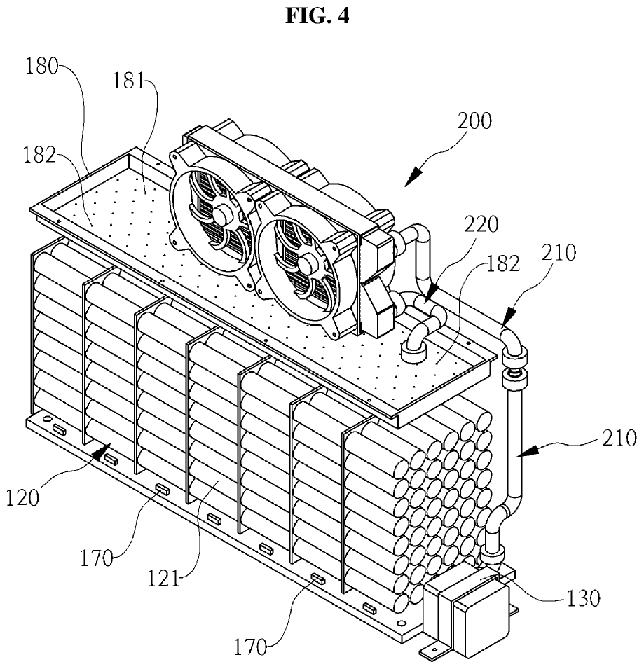

FIG. 3 is a diagram illustrating a cross section of a battery reception device used in one embodiment of the present invention, and FIG. 4 is a diagram illustrating the internal structure of the battery reception device. Referring to FIGS. 3 and 4, the dispersing unit 180 is disposed above the stacked battery cells 121 to evenly spray the insulating coolant to the battery cells 121.

The circulation pump 130 is disposed at one side of the battery unit 120 and is connected to the circulation pipe 210. The circulation pump 130 is preferably disposed in a suction head recess (not illustrated) that is lower than the bottom of the casing 110. That is, the suction head recess that is lower than the bottom surface of the battery unit 120 is provided, and the circulation pump 130 is disposed in the suction head recess.

The circulation pump 130 has the suction port and the discharge port. The insulating coolant is introduced into the circulation pump 130 through the suction port, is pressurized through a pumping action, and is discharged to the circulation pipe 220 through the discharge port. The difference in height between the center of the suction port and the level of the insulating coolant is the effective suction head. Since the circulation pump 130 can properly operate without generating bubbles only when the effective suction head is satisfied, the insulating coolant in the casing 110 needs to maintain a predetermined level that satisfies the effective suction head. When the installation position of the circulation pump 130 is high, the position of the suction port of the circulation pump 130 is high. In this case, the level of the insulating coolant is required to be raised to satisfy the effective suction head. Conversely, as the height at which the circulation pump 130 is installed is decreased, the level of the insulating coolant for satisfying the effective suction head decreased. In order to minimize the use of an expensive insulating coolant, the circulation pump 130 is installed at a lower position than other configurations. That is, the circulation pump 130 is installed in the suction head recess lower than the bottom of the casing 110. In this case, the level of the insulating coolant to satisfy the effective suction head is lowered.

The cooling unit 200 is provided with a plurality of heat-dissipating fins each of which extends in a horizontal direction. The insulating coolant introduced into the cooling unit 200 through the circulation pipe 210 performs heat exchange with the heat-dissipating fins and then flows into the discharge pipe 220.

The operation of the circulation pump 130 is controlled by the controller 140. Specifically, the circulation pump 130 continuously or intermittently operates on the basis of the result of comparison between a measured temperature and a preset temperature. The insulating coolant introduced into the cooling unit through the circulation pipe 210 connected to a first side of the cooling chamber is cooled by the heat-dissipating fins and the cooling fan, and is then discharged to the outside through the discharge pipe 220.

The discharge pipe 220 is connected to a second side of the cooling chamber so that the insulating coolant cooled in the cooling chamber flows into the dispersing unit 180 disposed under the cover of the casing 110. The dispersing unit 180 includes a storage portion 181 and a discharge hole 182. The dispersing unit 180 is disposed adjacent to one side of the discharge pipe 220, and it is preferable to be detachable from the discharge pipe 220.

The dispersing unit 180 is formed wide to correspond to the area of the top surface of the battery unit 120. The storage portion 181 of the dispersing unit 180 contains the insulating coolant introduced through the discharge pipe 220. The dispersing unit 180 sprays the insulating coolant so that the insulating coolant falls down through discharge holes 182 and scatters sideways while falling. The sizes, shapes, the installation positions, and the number of the discharge holes 182 diversely vary as necessary. Preferably, the discharge holes 182 are positioned above the vent holes (not illustrated) of the battery cells 121 so that an extinguishing agent which will be described later is directly injected and introduced into the vent holes.

When the temperature of the insulating coolant or the internal temperature of the battery reception device 100 increases, the controller 160 receives temperature detection signals transmitted from multiple temperature sensing units 170 and determines whether each of the temperature detection signals is within a preset allowable temperature range.

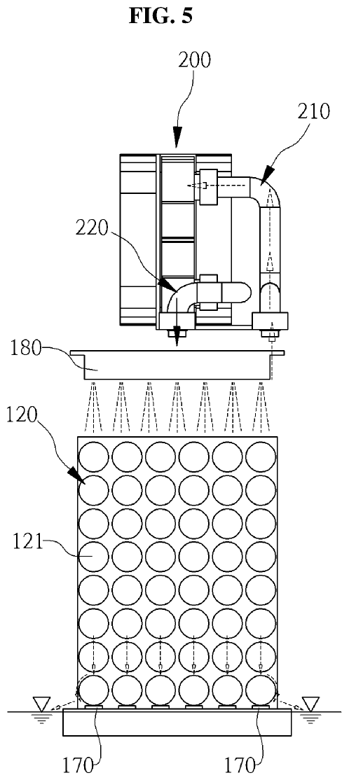

FIG. 5 is a diagram illustrating a state in which the insulating coolant is cooled and supplied to the battery reception device. Referring to FIG. 5, the insulating coolant undergoes heat exchange in the cooling unit, temporarily collects in the dispersing unit 180, and falls through the discharge holes 182 to be evenly spread. The dropped insulating coolant comes into contact with the surface of the battery cells 121 of the battery unit 120 and flows down along the surface, thereby removing the heat of the battery cells 121. When the insulating coolant reaches the bottom of the casing, the insulating coolant temporarily stays before being discharged to the outside by the circulation pump 130. Thus, the insulating coolant is maintained at a predetermined level in the casing.

Since the insulating coolant is expensive, it is not desirable that the casing contains a large volume of insulating coolant. Therefore, the level of the insulating coolant contained in the casing is set to a predetermined value, and the insulating coolant is desirably pumped out of the casing by the circulation pump 130, is then cooled by the cooling unit 200, and is returned to the casing. That is, the insulating coolant is recycled. The amount of the insulating coolant naturally decreases due to evaporation or leakage. In the case of a conventional art, since the whole insulating coolant is circulated, it is impossible to avoid a situation in which the amount of the insulating coolant becomes insufficient. When such an event occurs, the cooling operation cannot be properly performed. Therefore, a configuration or function that can replenish the insulating coolant or perform various control operations according to an optimal circulation rate during the cooling operation is required.

In addition, when some battery cells are not cooled or a fire occurs due to an abnormal condition such as an external shock, it is difficult to extinguish the fire with only the insulating coolant. In particular, since the fire of a battery is a composite fire, there are cases in which only a particular extinguishing agent exhibits a fire suppression effect. For this reason, a coolant used to cool a battery is required to have not only a cooling function but also a fire suppression function.

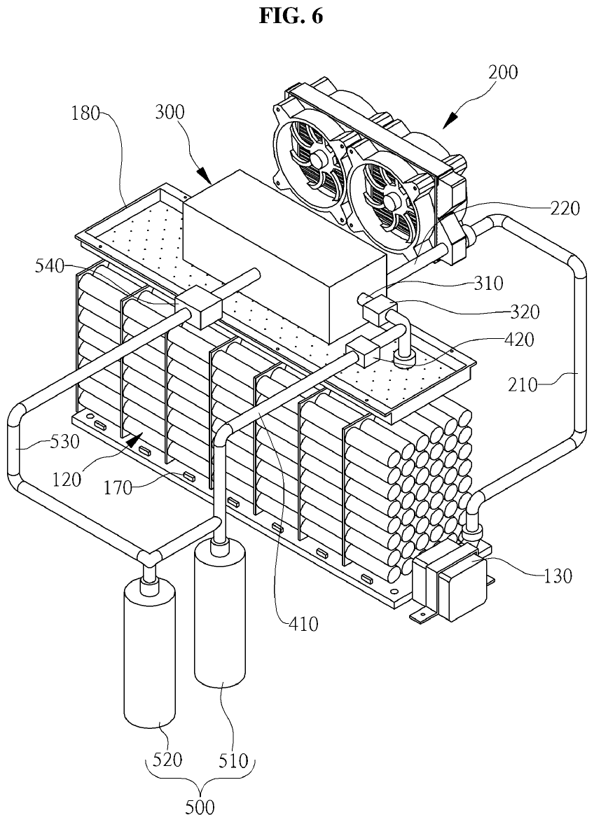

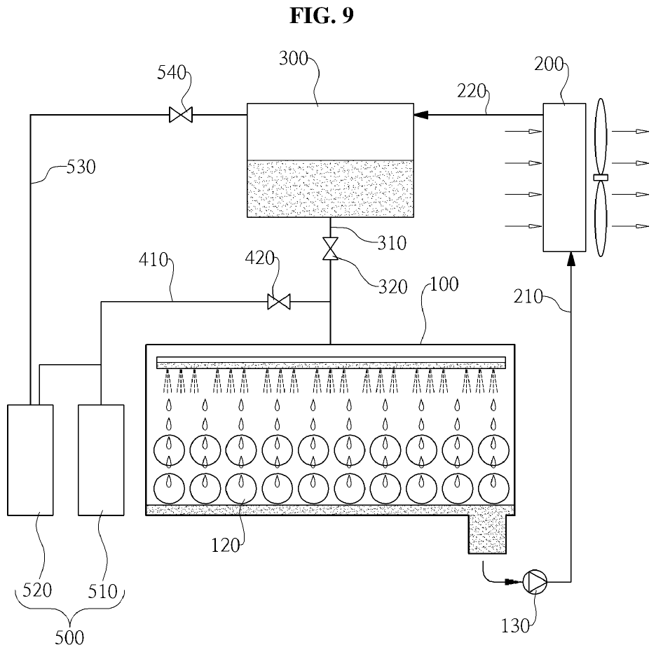

FIG. 6 is a diagram illustrating a battery reception device used in one embodiment of the present invention, and FIG. 9 is a diagram illustrating a connection structure of a battery thermal management device according to one embodiment of the present invention. Referring to FIGS. 6 and 9, a storage vessel 300 and a fire extinguishing device 500 are added to an existing configuration.

The storage vessel 300 is connected to the discharge pipe 220 of the cooling unit 200 so that the insulating coolant flows into the storage vessel 300. The storage vessel 300 is configured to contain a predetermined amount of an insulating coolant and is connected to an inflow pipe 310 that communicates with the internal space of the casing 110. An insulating coolant supply valve 320 is disposed on the inflow pipe 310.

The fire extinguishing device 500 includes an extinguishing agent storage vessel 510 and a pressurized gas storage vessel 520, and the extinguishing agent supplied from the fire extinguishing device 500 is introduced into the casing 110 through an extinguishing pipe 410. An extinguishing agent supply valve 420 is disposed on the extinguishing pipe 410 to open and close the extinguishing pipe 410, and an end of the extinguishing pipe 410 is directly connected the casing 110 or is connected to the inflow pipe 310.

The extinguishing agent storage vessel 510 is filled with a compressed air foaming extinguishing agent, and is preferably disposed outside or inside the structure of the system. Examples of the compressed air foaming extinguishing agent contained in the extinguishing agent storage vessel 510 include a foaming agent, ultrapure water, or other fluids having an extinguishing effect. It is preferable to use an eco-friendly compressed air foaming extinguishing agent.

The compressed air foaming extinguishing agent contained in the extinguishing agent storage vessel 510 generates bubbles with a high expansion ratio of 500 times or more. The agent has an oxygen blocking effect (suffocating) and a cooling effect. That is, it suffocates fire by surrounding the fire with bubbles which prevent combustible vapor from coming into contact with oxygen, and moisture contained in the bubbles has a cooling effect. Therefore, this agent can effectively cope with a battery fire having unique characteristics such as thermal runaway and re-ignition. In addition, the compressed air foaming extinguishing agent contains various types of inert gases so that oxygen blocking and cooling effects can be maximized, thereby being suitably used to extinguish fire in a lithium ion battery.

The extinguishing agent storage vessel 510 is connected to the pressurized gas storage vessel 520 so that the extinguishing agent is mixed with the pressurized gas in the chamber. Thus, the mixed and pressurized foaming agent is supplied. The produced chemical mixture includes: an extinguishing gas that is, for example, argon which has the most inert effect; and a compressed air foaming extinguishing agent which has an excellent cooling effect and an excellent oxygen blocking effect. The chemical mixture is improved in adhesion and thus has an advantage of maximizing the cooling and oxygen blocking effects even with a small amount.

The fire extinguishing device 500 includes the extinguishing agent storage vessel 510 as a basic component, and the extinguishing agent discharged from the fire extinguishing device 500 is moved along the extinguishing pipe 410. In addition, the pressurized gas storage vessel 520 is connected. The pressurized gas and the extinguishing agent are mixed, and the pressurized extinguishing agent is ejected with a strong force.

The pressurized gas storage vessel 520 discharges a pressurized gas to the extinguishing agent storage vessel 510 and supplies the pressurized gas to the storage vessel 300 through a separate pressurized gas pipe 530. The pressurized gas storage vessel 520 is connected to the extinguishing pipe 410, and the pressurized gas pipe 530 is connected to the storage vessel 300. The pressurized gas supply valve 540 is provided on the pressurized gas pipe 530 so that pressurized gas is supplied to the storage vessel 300 or is blocked according to the opening/closing operation of the pressurized gas supply valve 540 under the control of the controller 140.

While a conventional art is configured such that the insulating coolant is supplied to the battery reception device 100 through only the cooling unit 200 and the discharge pipe 220, the present invention is configured such that the storage vessel 300, the inflow pipe 310, and the insulating coolant supply valve 320 are disposed between the discharge pipe 220 and the battery reception device 100.

In addition, the extinguishing device 500 and the extinguishing pipe 410 are connected to the battery reception device 100. Therefore, when necessary or when a fire is detected, the insulating coolant supply valve 320 is closed and the extinguishing agent supply valve 420 is opened so that the extinguishing agent can be supplied to extinguish a fire.

In addition, the pressurized gas storage vessel 520 of the fire extinguishing device 500 is used to connect the storage vessel 300 and the pressurized gas pipe 530 so that the pressurized gas can be supplied to the storage vessel 300. Thus, the insulating coolant contained in the storage vessel 300 is pressurized and is thus ejected at high speed.

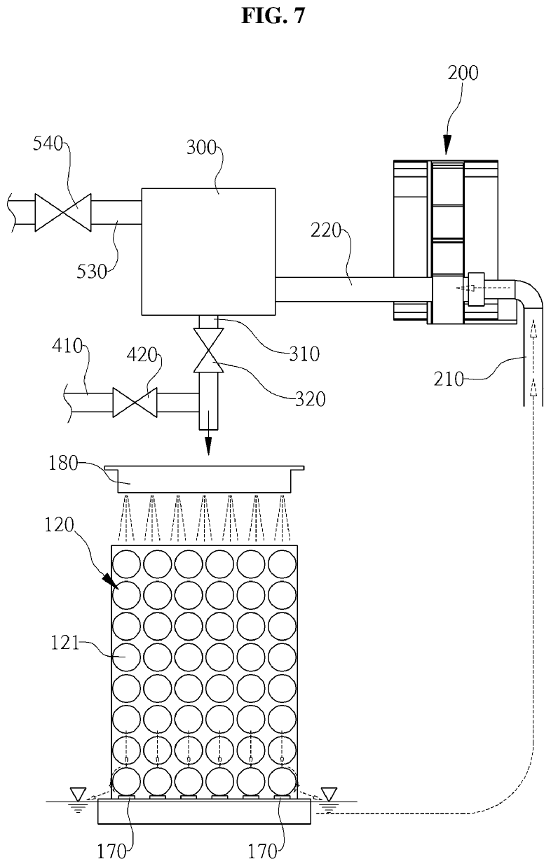

FIG. 7 is a diagram illustrating a connection structure of a battery thermal management device according to one embodiment of the present invention. Referring to FIG. 7, various operations are performed for battery thermal management.

### (1) Circulation Operation

The circulation pump 130 operates in a normal state. In order to minimize power consumption, the circulation pump 130 is periodically activated and deactivated according to the temperature measured by the temperature sensing unit 170.

### (2) Cooling Operation

When the temperature measured by the temperature sensing unit 170 is at or above a reference temperature, the circulation pump 130 continuously operates, and the cooling fan of the cooling unit 200 continuously or briefly operates.

### (3) Overheat Control Operation

When the temperature does not drop during the cooling operation but rather continuously rises, an overheat control operation is performed. The overheat control operation refers to an operation of temporarily raising the level of the insulating coolant in the casing 110.

The storage vessel 300 is provided, and a certain amount of the insulating coolant is contained in the storage vessel 300. In normal conditions, the insulating coolant maintains a minimum level required for pumping in the casing 110.

In order to prevent problems such as the deterioration of the cooling performance due to the leakage loss or evaporation loss of the insulating coolant falling down into the casing, that is, to prevent an event in which the amount of the insulating coolant is reduced or the level of the insulating coolant is lowered, the amount of the insulating coolant needs to be maintained to the extent that is more than required for minimum cooling.

However, since the insulating coolant is expensive and heavy, it is not desirable that the amount of the insulating coolant contained in the casing 110 exceeds the minimum amount required for pumping. Therefore, a redundant amount of the insulating coolant is contained in the storage vessel 300, and an additional amount of the insulating coolant is transferred to the battery reception device 100 only when it is necessary to replenish the insulating coolant in the casing 110. In this way, it is possible to maintain or control the optimum level of the insulating coolant in the casing 110. In normal conditions, a predetermined amount of an insulating coolant is stored in the storage vessel 300, and the insulating coolant contained in the casing 110 is maintained at a low level by adjusting the opening of the insulating coolant supply valve 320.

When the temperature measured by the temperature sensing unit 170 does not drop, is above a reference temperature, or rather rises during the cooling operation, the overheating control operation is performed. In the operation, the flow rate of the insulating coolant supplied to the casing 110 from the storage vessel 300 is temporarily increased so that the level of the insulating coolant in the casing 110 rises. To this end, the opening of the insulating coolant supply valve 320 is increased. In addition, it is possible to control the circulation pump 130 not to discharge or to reduce the amount of the insulating coolant discharged therefrom.

Through this operation, the amount of the insulating coolant introduced into the battery reception device 100 is increased to be larger than the amount of the insulating coolant discharged from the battery reception device 100. In this case, the level of the insulating coolant contained in the casing 110 rises, and thus the battery cells 121 are submerged in the insulating coolant.

Thereafter, when the temperature measured by the temperature sensing unit 170 falls to or below the reference temperature, the level of the insulating coolant in the casing is controlled to be lowered. To this end, the insulating coolant supply valve 320 is temporarily closed or the opening of the insulating coolant supply valve 320 is reduced. In addition, the operation of the circulation pump 130 is stopped or the pumping rate of the circulation pump 310 is increased.

In one embodiment, multiple battery reception devices 100 are connected to one central storage vessel 300. In this case, the multiple battery reception devices 100 may share the storage vessel 300 and the cooling unit 200. Each battery reception device 100 maintains the minimum amount of the insulating coolant in the casing thereof, and a large amount of the insulating coolant is contained in the central storage vessel 300. When any one of the battery reception devices 100 overheats and thus undergoes a heat control operation, the insulating coolant stored in the central storage vessel 300 is supplied to the battery reception device 100 to raise the level of the insulating coolant. When the battery reception device 100 enters a normal steady state, the insulating coolant is returned to the storage vessel from the battery reception device 100. That is, since the insulating coolant stored in the storage vessel is shared by the multiple battery reception devices and is recovered to the storage vessel 300 when the battery overheating is resolved, there is an effect that the overheating control operation can be performed while minimizing and optimizing the amount of the insulating coolant contained in the battery reception device in normal conditions.

### (4) Fire Detection Operation

When it is determined that a fire has occurred in all or part of the battery units 120 or in all or part of the battery cells 121 in the battery reception device 100 on the basis of the temperature measured by the temperature sensing unit 170, an extinguishing operation is performed. In this case, it is determined that it is impossible to extinguish the fire with only the control of the level of the insulating coolant in the casing, and thus the extinguishing agent is introduced into the casing.

Under the control of the controller 140, the insulating coolant supply valve 320 installed in the inflow pipe 310 connected to the storage vessel 300 is closed, and the extinguishing agent supply valve 420 installed in the extinguishing pipe 410 connected to the fire extinguishing device 500 is opened. In this case, to extinguish the fire, the extinguishing agent is supplied to the casing 110 instead of the insulating coolant.

### (5) Re-Ignition Prevention Operation

After fire detection and extinguishing, re-ignition occurs sometimes. In order to prevent re-ignition, an insulating coolant must be supplied again after the extinguishing operation is performed. This operation is called “re-ignition prevention operation”.

The primary cooling function of the foaming extinguishing agent that is sprayed in the event of a fire is water-based cooling. Water is effective for extinguishing at temperatures over 100° C. but is not effective for extinguishing at temperatures below 100° C. Therefore, it is necessary to lower the temperature of a battery to below 100° C. using the foaming extinguishing agent and to detect the temperature. When the detected temperature is still higher than the evaporation temperature of the insulating coolant, an additional amount of insulating coolant needs to be injected into the casing. In order to prevent re-ignition, when the battery temperature is lower than the evaporation temperature of the extinguishing agent such as water but is higher than the temperature of the insulating coolant, the insulating coolant is supplied again.

To this end, the extinguishing agent supply valve 420 is closed and the insulating coolant supply valve 320 is opened so that the insulating coolant can be introduced into the casing from the storage vessel 300. In this case, the circulation pump 130 is activated. When there is a failure or damage of the circulation pump 130 due to a fire, a pressurized gas is supplied to the storage vessel 300 from the pressurized gas storage vessel 520 so that the insulating coolant in the storage vessel 300 is pushed out of the storage vessel 300. The insulating coolant storage vessel 300 serves to lower the level of the insulating coolant in the casing 110 and to receive the pressurized gas for additional cooling during the re-ignition prevention operation. If there is no storage vessel 300, it is not possible to additionally supply the insulating coolant when the circulation pump 130 fails, and there is no way to utilize the pressurized gas storage vessel 520 of the fire extinguishing device 500. Thus, it is impossible to perform the conjugate operation of additionally supplying the insulating coolant remaining in the storage vessel 300 and using the pressurized gas storage vessel 520.

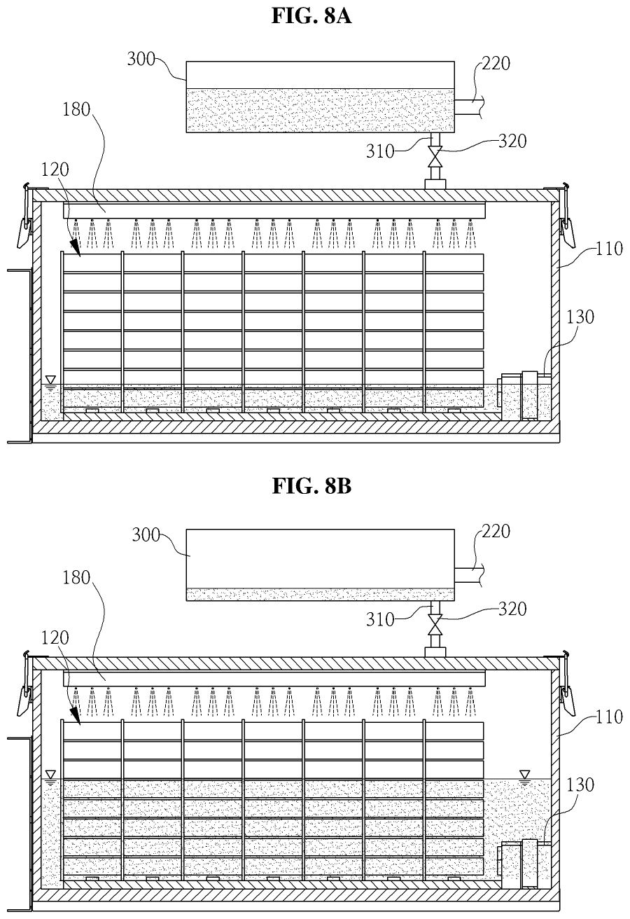

FIGS. 8A and 8B are diagrams illustrating a state in which a level of an insulating coolant in a battery reception device changes, according to one embodiment of the present invention. During a normal operation, the minimum appropriate coolant level is maintained as shown in FIG. 8A. When the internal temperature rises to exceed a reference temperature or does not drop below the reference temperature even though the cooling operation is performed, the level of the insulating coolant is raised as shown in FIG. 8B through the overheating control operation.

To this end, more insulating coolant is supplied to the casing from the storage vessel 300 through the inflow pipe 310 and the discharge rate of the insulating coolant from the circulation pump 130 is reduced. When the overheating control operation ends, the amount of the insulating coolant supplied to the casing from the storage vessel 300 is reduced and/or the discharge rate of the insulating coolant from the circulation pump 130 is increased so that the level of the insulating coolant is restored to the initial level. In conventional arts, it was not possible to perform the operation of raising or lowering the water level. However, according to the present invention, an additional storage vessel 300 configured to contain a redundant amount of insulating coolant is included, and the insulating coolant is circulated in a first-in-first-out manner. Therefore, it is possible to maintain the cooling performance even in the event of leakage or evaporation loss of the insulating coolant by replenishing the insulating coolant using the storage vessel 300.

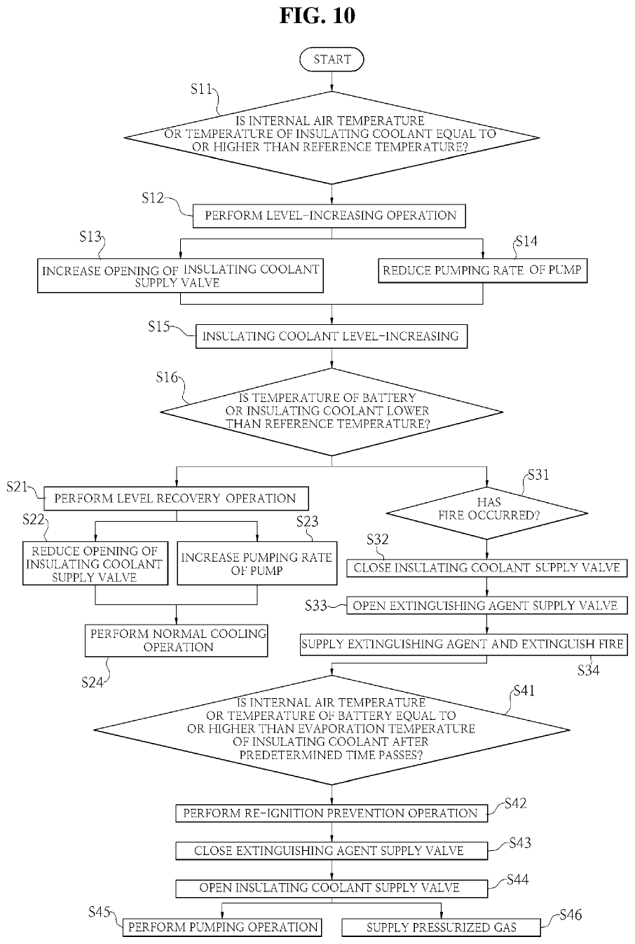

FIG. 10 is a flowchart illustrating a thermal management control method according to one embodiment of the present invention. Referring to FIG. 10, among various operations including a circulation operation, a cooling operation, an overheating control operation, a fire detection operation, a re-ignition prevention operation that can be performed by the controller 140, only the overheating control operation, the fire detection operation, and the re-ignition prevention operation are illustrated in the flowchart.

The overheating control operation is to raise the level of the insulating coolant in the casing 110 of the battery reception device 100 (step S12) when it is determined that the internal temperature of any one battery reception device 100 or the temperature of the insulating coolant is equal to or higher than a reference temperature (step S11). To this end, the insulating coolant supply valve 320 is adjusted to increase the amount of the insulating coolant supplied to the casing from the storage vessel 300 (step S13) and/or to reduce the amount of insulating coolant discharged from the circulation pump 130 (step S13). The excessive insulating coolant stored in the storage vessel 300 temporarily moves into the casing 110 to raise the level of the insulating coolant (step S15).

Thereafter, when the temperature of the battery cell 121, the temperature of the insulating coolant, or the internal temperature of the casing 110 drops to below the reference temperature, the overheating control operation is stopped, the level of the insulating coolant is lowered again, and the insulating coolant is returned to the central storage vessel 300 (step S21). For this return operation, the supply of the insulating coolant from the storage vessel 300 to the casing is reduced or is temporarily stopped (step S22), and/or the amount of insulating coolant discharged from the circulation pump 130 is increased (step S23). Subsequently, the circulation operation and the normal cooling operation are performed (step S24).

When the temperature does not drop or when it is assumed that there is an internal fire through various known methods (step S31), a fire detection operation is performed. To this end, the insulating coolant supply valve 320 is closed (step S32) and the extinguishing agent supply valve 420 is opened (step S33) so that the extinguishing agent is supplied from the fire extinguishing device 500 to the battery reception device, thereby extinguishing the fire.

When it is determined that the temperature measured after the fire suppression is higher than the evaporation temperature of the insulating coolant (step S41), the re-ignition prevention operation is performed (step S42). In order to prevent that a fire locally recurs at a portion where contact with the insulating coolant is insufficient, the insulating coolant is supplied again.

For the re-ignition prevention operation, the extinguishing agent supply valve 420 is closed (step S43) and the insulating coolant supply valve 320 is opened (step S44). Thus, the insulating coolant that remains in the storage vessel 300 or the insulating coolant that is pumped by the circulation pump 130 is supplied to the battery unit 120 through the pumping operation (S45). When the circulation pump 130 is not operated due to the damage caused by the fire, when it is impossible to perform the circulation process, or when it is necessary to eject the insulating coolant at high pressure, the pressurized gas stored in the pressurized gas storage vessel 520 is supplied to the storage vessel 300 so that the insulating coolant is pushed out of the storage vessel 300 at high pressure and speed (step S46).

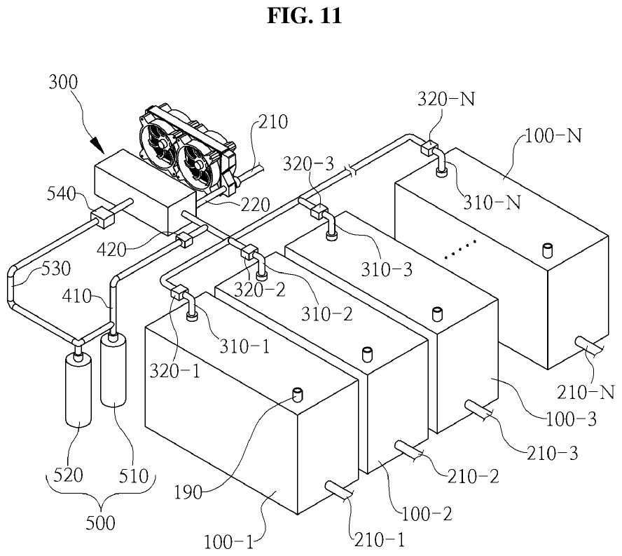

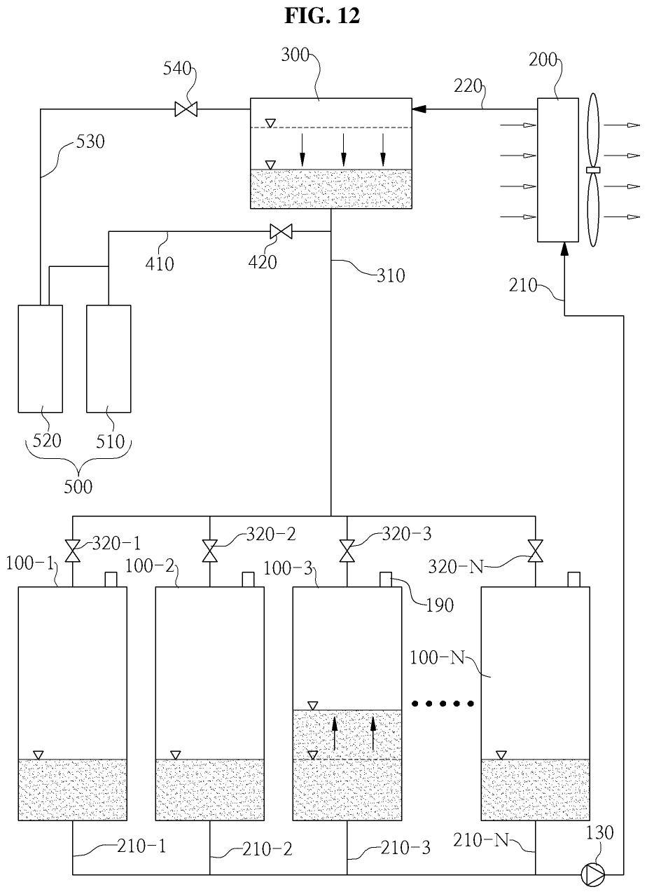

FIG. 11 is a diagram illustrating a battery thermal management device according to another embodiment of the present invention, and FIG. 12 is a diagram illustrating a state in which the level of an insulating coolant contained in a battery reception device changes. Referring to FIG. 11, one storage vessel 300 is connected to multiple battery reception devices 100-1, 100-2, 100-3, . . . , and 100-N. Therefore, the insulating coolant can be simultaneously supplied to the multiple battery reception devices 100-1, 100-2, 100-3, . . . , and 100-N from only one storage vessel 300.

Multiple bifurcated inflow pipes 310-1, 310-2, 310-3, . . . , and 310-N are connected to the battery reception devices 100-1, 100-2, 100-3, . . . , and 100-N, respectively. The multiple inflow pipes 310-1, 310-2, 310-3, . . . , and 310-N are respectively provided with respective insulating coolant supply valves 320-1, 320-2, 320-3, . . . , and 320-N. Each of the insulating coolant supply valves 320-1, 320-2, 320-3, . . . , and 320-N is individually opened or closed. Therefore, the amount of the insulating coolant or the amount of the extinguishing agent supplied to a corresponding one of the battery reception devices 100-1, 100-2, 100-3, . . . , and 100-N can be controlled. The introduced extinguishing agent is discharged to each of the circulation pipes 210-1, 210-2, 210-3, . . . , and 210-N) and is thus returned to the storage vessel 300.

A pressure control valve 190 is provided at an upper portion of the casing 110 to control the internal pressure of the sealed casing 110. That is, the pressure control valve 190 enables the rapid inflow of the fluid and prevents the occurrence of a negative pressure. When the level of the insulating coolant needs to be raised, it is desirable to discharge internal air from the casing for rapid inflow of the fluid. Conversely, when the level of the insulating coolant needs to be lowered, it is preferable to introduce external air into the casing to prevent a negative pressure.

Referring to FIG. 12, when it is determined that the temperature of any one battery reception device 100-3 of the battery reception devices 100-1, 100-2, 100-3, . . . , and 100-N exceeds a reference value in a situation in which the insulating coolant is supplied to each of the battery reception devices 100-1, 100-2, 100-3, . . . , and 100-N from the storage vessel 300 at the same flow rate, the supply of the insulating coolant to the battery reception device 100-3 is increased by controlling the insulating coolant supply valve 320-3 and the circulation pump 130 so that the level of the insulating coolant in the battery reception device 100-3 rises. Although only one circulation pump 130 is illustrated in the drawings, multiple circulation pumps 130 may be disposed to correspond to the respective battery reception devices 100-1, 100-2, 100-3, . . . , and 100-N.

In this case, while the level of each of the battery receiving devices 100-1, 100-2, . . . , and 100-N other than the battery reception device 100-3 remains unchanged, the level of the storage device 300 descends and the level of the insulating coolant in the battery reception device 100-3 ascends. As the level ascends, the contact area between the insulating coolant and the battery cell 121 and the contact time increase. In this case, the pressure adjustment valve 190 allows the internal air to be discharged from the casing of the battery reception device 100-3 so that the flow of the insulating coolant into the battery reception device 100-3 is facilitated.

When the internal temperature of the battery reception device 100-3 is restored to the normal range due to an increase in the level of the insulating coolant, the level of the insulating coolant in the battery reception device 100-3 descends and the excessive insulating coolant is discharged. In this case, the pressure adjustment valve 190 enables external air to be introduced into the battery reception device 100-3 to prevent an internal negative pressure.

The excessive insulating coolant is discharged, cooled, and then introduced into the storage vessel 300. That is, the level of the insulating coolant in the storage vessel 300 is recovered so that it can be supplied to another battery reception device as necessary.

This effect is numerically conceptualized such that when 10 sets of battery reception devices 100 are arranged and each of the battery reception devices 100 requires 3 L of insulating coolant in normal conditions and 10 L of insulating coolant in an emergency condition, 10 L of insulating coolant is required for each set of battery reception devices. That is, a total of 100 L of insulating coolant is required (10 sets×10 L=100 L). However, in the above-described embodiment in which the centralized storage vessel 300 and the multiple reception devices 100 are used, each of the battery reception devices 100 contains the minimum amount (3 L) of insulating coolant, the storage vessel 300 contains 7 L of insulating coolant, and the 7 L of the insulating coolant contained in the storage vessel 300 is temporarily supplied to one of the battery reception devices 100 that needs to be replenished with the insulating coolant so that the total amount of the insulating coolant in the battery reception unit 100 becomes 10 L. In this case, only 37 of insulating coolant is needed (7 L in storage vessel and 7 L per set×10 sets=37 L). Therefore, it is possible to reduce the consumption of an expensive insulating coolant.

While this specification describes many features, it should be not be construed that the scope of the present invention be limited to the described features. In addition, features described in separate embodiments of the present specification may be combined and implemented in a single embodiment. Conversely, various features described in a single embodiment of the present specification may be separately implemented in various embodiments, or may be properly implemented in combination.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A battery thermal management device comprising:
a battery reception device including a casing for receiving a battery unit and for containing an insulating coolant;
the battery unit including multiple battery cells stacked on each other;
a circulation pump disposed at one side of the battery unit and configured to discharge the insulating coolant to the outside from the casing;
a cooling unit that is connected to the circulation pump and into which the insulating coolant discharged from the circulation pump is introduced during operation of the circulation pump;
a storage vessel that stores the insulating coolant that is cooled by the cooling unit;
an insulating coolant supply valve installed on a path through which the insulating coolant discharged from the storage vessel is introduced into the casing, thereby opening or closing the path or adjusting a flow rate of the insulating coolant;
a temperature sensing unit that measures an internal temperature of the battery unit, an internal temperature of the casing, or a temperature of the insulating coolant; and
a controller that controls at least one of operation of the circulation pump, operation of the cooling unit, and the supply valve according to the temperature measured by the temperature sensing unit.

2. The device according to claim 1, further comprising:
a fire extinguishing device containing an extinguishing agent; and
an extinguishing agent supply valve installed on a path through which the extinguishing agent discharged from the fire extinguishing device flows into the casing to open and close the path or to control a flow rate of the extinguishing agent.

3. The device according to claim 2, wherein the fire extinguishing device comprises: an extinguishing agent storage vessel containing the extinguishing agent; and a pressurized gas storage vessel containing a pressurized gas,
wherein the battery thermal management device further comprises: a pressurized gas pipe connected between the storage vessel and the fire extinguishing device; and a pressurized gas supply valve installed on the pressurized gas pipe, and
wherein when the pressurized gas supply valve is opened, the pressurized gas is supplied to the storage vessel from the fire extinguishing device and the insulating coolant in the storage vessel is pressurized and supplied to the battery reception unit.

4. A battery thermal management device comprising:
a battery reception device including a casing for receiving a battery unit and for containing an insulating coolant;
a circulation pump configured to discharge the insulating coolant from the casing;
a cooling unit that is connected to the circulation pump and into which the insulating coolant discharged from the circulation pump is introduced during operation of the circulation pump;
a storage vessel that stores the insulating coolant that is cooled by the cooling unit;
an insulating coolant supply valve installed on a path through which the insulating coolant discharged from the storage vessel is introduced into the casing, thereby opening or closing the path or adjusting a flow rate of the insulating coolant;
a temperature sensing unit that measures an internal temperature of the battery unit, an internal temperature of the casing, or a temperature of the insulating coolant; and
a controller that performs control to raise or lower a level of the insulating coolant in the battery reception device according to a temperature detection signal input from the temperature sensing unit.

5. The device according to claim 4, wherein when it is determined that the temperature measured by the temperature sensing unit is equal to or higher than a reference temperature, the controller opens the insulating coolant supply valve, increases an opening of the insulating coolant supply valve, stops the circulation pump from discharging the insulating coolant, or reduces a flow rate of the insulating coolant discharged from the circulation pump so that a flow rate of the insulating coolant introduced into the battery reception device is higher than a flow rate of the insulating coolant discharged from the battery reception device and thus the level of the insulating coolant in the battery reception device rises.

6. The device according to claim 4,
wherein when it is determined that the temperature measured by the temperature sensing unit is lower than a reference temperature, the controller closes the insulating coolant supply valve, reduces an opening of the insulating coolant supply valve, controls the circulation pump to start discharging the insulating coolant, or controls the circulation pump to increase a flow rate of the insulating coolant discharged therefrom so that a flow rate of the insulating coolant introduced into the battery reception device is lower than a flow rate of the insulating coolant discharged from the battery reception device and thus the level of the insulating coolant in the battery reception device descends.

7. The device according to claim 2,
wherein when it is determined that a fire occurs in the storage vessel, the controller closes the insulating coolant supply valve to block the insulating coolant supplied from the storage vessel and opens the extinguishing agent supply valve to allow the extinguishing agent to be introduced into the battery reception device from the fire extinguishing device.

8. The device according to claim 7, wherein when it is determined that a state in which the temperature measured by the temperature sensing unit is equal to or higher than an evaporation temperature of the insulating coolant lasts for a predetermined period of time or longer, the controller closes the extinguishing agent supply valve to prevent the extinguishing agent from being introduced into the battery reception device, and opens the insulating coolant supply valve to allow the insulating coolant to be introduced into the battery reception device from the storage vessel.

9. The device according to claim 8, wherein the fire extinguishing device comprises:
an extinguishing agent storage vessel containing the extinguishing agent; a pressurized gas storage vessel containing a pressurized gas;
a pressurized gas pipe connected between the storage vessel and the extinguishing device; and
a pressurized gas supply valve installed on the pressurized gas pipe to allow the insulating coolant to be supplied to the battery reception device from the storage vessel,
wherein the controller opens the pressurized gas supply valve so that the pressurized gas is supplied to the storage vessel from the extinguishing device and the insulating coolant in the storage vessel is pressurized and supplied to the battery reception unit.

10. A battery thermal management method comprising:
introducing an insulating coolant into a casing of a battery reception device accommodating a battery unit so that the insulating coolant comes into direct contact with the battery unit;
discharging the insulating coolant from the casing using a circulation pump;
cooling the discharged insulating coolant through heat exchange in a cooling unit;
storing the insulating coolant that is cooled by the cooling unit in a storage vessel; and
raising or lowering a level of the insulating coolant in the battery reception device under control of a controller.

11. The method according to claim 10, further comprising:
measuring an internal temperature of the battery unit, an internal temperature of the casing, or a temperature of the insulating coolant using a temperature sensing unit; and
temporarily raising the level of the insulating coolant contained in the battery reception device when it is determined that the measured temperature is equal to or higher than a reference temperature,
wherein the temporarily raising comprises: opening the insulating coolant supply valve, increasing an opening of the insulating coolant supply valve; and stopping discharge of the insulating coolant from the circulation pump, or reducing a flow rate of the insulating coolant discharged from the circulation pump, so that a flow rate of the insulating coolant introduced into the battery reception device is higher than a flow rate of the insulating coolant discharged from the battery reception device and thus the level of the insulating coolant in the battery reception device rises.

12. The method according to claim 10, further comprising:
determining whether a fire occurs in the battery reception device; and
supplying an extinguishing agent to the battery reception device when it is determined that a fire occurs in the battery reception device,
wherein the supplying of the extinguishing agent is a process of opening an extinguishing agent supply valve so that the extinguishing agent is introduced into the battery reception device from a fire extinguishing device.

13. The method according to claim 12, further comprising:
determining whether a state in which the temperature measured by the temperature sensing unit is equal to or higher than an evaporation temperature of the insulating coolant lasts for a predetermined period of time or longer; and
preventing re-ignition in the battery reception device,
wherein the preventing of the re-ignition comprises:
closing the extinguishing agent supply valve to prevent the extinguishing agent from being introduced into the battery reception device, and
opening the insulating coolant supply valve to allow the insulating coolant to be introduced into the battery reception device from the storage vessel.

14. The method according to claim 13, further comprising:
opening a pressurized gas supply valve installed on a pressurized gas pipe connected between the storage vessel and a pressurized gas storage vessel;
allowing a pressurized gas in the pressurized gas storage vessel to be introduced into the storage vessel; and
allowing the insulating coolant in the storage vessel to be pressurized and supplied to the battery reception device by the introduced pressurized gas.
